(19) United States
(12) Patent Application Publication
(10) Pub. No.: US 2010/0122277 A1
(43) Pub. Date: May 13, 2010

(54) DEVICE AND A METHOD FOR PLAYING AUDIO-VIDEO CONTENT

(75) Inventor: PEDRO FONSECA, Eindenhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJIKE PHILLIPS ELECTRONICS, N.V., Eindhoven (NL)

(21) Appl. No.: 12/307,941

(22) PCT Filed: Jun. 27, 2007
(86) PCT No.: PCT/IB07/52491

§ 371 Date: Jan. 8, 2009

(30) Foreign Application Priority Data
Jul. 12, 2006 (EP) 06117006.4

(51) Int. Cl. H04H 60/33

(52) U.S. Cl. 725/10

(57) ABSTRACT

A device and a method for playing audio-video content (205) during which loss of attention of a user (192) is detected. Loss of attention of the user generates at least one attention loss marker (255) that is stored in an attention loss storage unit (210). The user may revert playback to a point in time corresponding to the attention loss marker using a user interface unit (190). By storing markers corresponding to points of attention loss by the user and requiring explicit user input, the attention loss detector may detect attention loss with an accuracy lower than would otherwise be the case. Optionally, storing of the attention loss markers may be made conditional upon a content analysis unit (420), such as a commercial block detector. An attention loss marker indication (260) may be made visible to the user to indicate that at least one attention loss marker has been detected.

### FIELD OF THE INVENTION

The invention relates to a device for playing audio-video content.

The invention further relates to a method for playing audio-video content.

The invention further relates to a program element.

The invention further relates to a computer-readable medium.

### BACKGROUND OF THE INVENTION

Consumer Electronics devices provide a wide variety of entertainment experiences to consumers from music and video playback to live television viewing. However, the entertainment experience can be spoilt by interruptions or distractions causing the attention of the consumer to be lost. In US Patent Application 2003/0097659A1 the display of a television program is paused automatically after detecting an event that indicates that the viewing experience of a viewer is likely to have been interrupted. The pausing is achieved by time-shifting the television program using storage. When the interruption is complete the time-shifted program may be resumed such that the viewer can continue viewing without missing a portion of the television program. Interruptions to the viewing experience may be an incoming telephone call, the receipt of an electronic message, or other events occurring in the home or in the environment of the device pausing the television program.

Further methods for detecting the loss of attention of a user include detecting the face of a consumer using a camera. Specifically, this may also include detecting whether the eyes of the consumer are open or closed or indeed in which direction the eyes are gazing. Acoustic methods known rely upon detecting predetermined sounds such as a doorbell or telephone ring tone. However, it has been found that the accuracy of detecting the attention loss of a consumer is rarely 100%, which in turn leads to an entertainment experience that is not entirely predictable for the consumer. For example, when the attention loss of a consumer is incorrectly identified automatically pausing the television program is undesired. The consumer may even find this irritating, leading to an entertainment experience that is actually poorer. Furthermore, in some situations the consumer purposely loses attention. For example, during commercial blocks. In these situations the consumer would be subjected to a poorer entertainment experience.

The inventors recognising this problem devised the present invention.

### BRIEF SUMMARY OF THE INVENTION

It would be advantageous to achieve an improved entertainment experience for a consumer even when the accuracy of detecting the attention loss of the consumer is not perfect.

Accordingly, there is provided, in a first aspect of the present invention, a device for playing audio-video content, the device comprising a storage unit for supplying the content to be played, a playback unit for playing the content from the storage unit, an attention loss detector for detecting at least one point of attention loss by a user during playing of the content by the playback unit, an attention loss storage unit for storing at least one attention loss marker corresponding to the at least one point of attention loss detected by the attention loss detector and a user interface unit for receiving user input from the user indicating that the playback unit should play the content from a point in time corresponding to the at least one attention loss marker.

According to a second aspect of the invention a method for playing audio-video content is provided, the method comprising playing the content to a user, detecting at least one point of attention loss by the user during the playing of the content, storing at least one attention loss marker corresponding to the at least one point of attention loss detected, receiving user input from the user indicating that the user desires to play the content from a point in time corresponding to the at least one attention loss marker and playing the content from a point in time corresponding to the at least one attention loss marker in response to the user input.

According to a third aspect of the invention a system for playing audio-video content is provided, comprising a first device, for detecting attention loss, and a second device, the second device comprising a playback unit for playing the content, wherein the first device comprises an attention loss detector for detecting at least one point of attention loss by a user during playing of the content by the second device, an attention loss storage unit for storing at least one attention loss marker corresponding to the at least one point of attention loss detected by the attention loss detector, a user interface unit for receiving user input from the user indicating that the content should be played from a point in time corresponding to the at least one attention loss marker and a remote device control unit, for controlling the playback unit of the second device in response to the user input to play the content from the point in time corresponding to the at least one attention loss marker.

According to a fourth aspect of the invention a program element directly loadable into a memory of a programmable device is provided, comprising software code portions for performing, when said program element is run on the device, the method steps of playing audio-video content to a user, detecting at least one point of attention loss by the user during the playing of the content, storing at least one attention loss marker corresponding to the at least one point of attention loss detected, receiving user input from the user indicating that the user desires to play the content from a point in time corresponding to the at least one attention loss marker and playing the content from a point in time corresponding to the at least one attention loss marker in response to the user input.

According to a fifth aspect of the invention a computer-readable medium directly loadable into a memory of a programmable device is provided, comprising software code portions for performing, when said code portions are run on the device, the method steps of playing audio-video content to a user, detecting at least one point of attention loss by the user during the playing of the content, storing at least one attention loss marker corresponding to the at least one point of attention loss detected, receiving user input from the user indicating that the user desires to play the content from a point in time corresponding to the at least one attention loss marker and playing the content from a point in time corresponding to the at least one attention loss marker in response to the user input.

Since the detection accuracy of detecting a loss of attention by the user is rarely perfect the entertainment experience is improved by ensuring that the audio-video content is not automatically paused in response to the detection of a loss of attention, but that a marker is stored indicating the detected point of attention loss. The user may then choose to ignore the detected attention loss or not. The detection accuracy of detecting a loss of attention is therefore less critical and will not automatically lead to a poorer entertainment experience. Furthermore, in situations where the user purposely loses attention the user may be given the option of resuming from the point of attention loss rather than being forced to overrule the automatically paused entertainment experience.

In one embodiment the attention loss storage unit may comprise an attention loss marker generator which may be communicatively coupled to the attention loss detector and the playback unit, for generating the at least one attention loss marker based upon a current playback point received from the playback unit and a point of attention loss indication received from the attention loss detector and an attention loss marker database which may be communicatively coupled to the attention loss marker generator and the playback unit, for storing and retrieving the at least one attention loss marker generated by the attention loss marker generator. This allows the playback and the detection of attention loss points to be synchronized and stored for easy retrieval, even when many points of attention loss are detected.

In a further embodiment the storage unit may comprise a random access unit for playing the content in a randomly addressable manner. The playback unit may be communicatively coupled to the storage unit to provide a playback pointer to address the content from the storage unit in the randomly addressable manner and the user interface unit may be communicatively coupled to the playback unit to indicate that the playback unit should communicate the playback pointer to the storage unit to play the content from a point in time corresponding to the at least one attention loss marker. This allows the content to be played directly from the point in time corresponding to the at least one attention loss marker without the requirement of rewinding and or searching in the storage unit for the correct point.

In another embodiment a recording unit may be provided for recording a broadcast signal, the recording unit may be communicatively coupled to the storage unit to record the broadcast signal. This allows broadcast signals to be recorded and points of attention loss to be detected in live television.

In yet another embodiment a content analyser may be provided communicatively coupled to the recording unit for analysing the content and generating at least one content segmentation marker indicating at least one segment within the content. The content analyser may be further communicatively coupled to the storage unit for storing the at least one content segmentation marker and the playback unit may be communicatively coupled to the storage unit to determine a playback pointer based upon the point in time corresponding to the at least one attention loss marker and the at least one content segmentation marker. The playback unit may further be adapted to play the content from a point in time corresponding to the playback pointer. This allows the actual point of resumption of playback of recorded content to be adjusted taking into account the segments or segment boundaries within the actual audio-video content itself. The content may be analysed at recording time or offline before playback.

In an embodiment a content analyser may be provided communicatively coupled to the storage unit for analysing the content and generating at least one content segmentation marker indicating at least one segment within the content and the playback unit may be communicatively coupled to the content analyser to determine a playback pointer based upon the point in time corresponding to the at least one attention loss marker and the at least one content segmentation marker. The playback unit may be further adapted to play the content from a point in time corresponding to the playback pointer. This allows the content to be analysed during playback, without any prior analysis, such that the actual point of resumption of playback of the content may be adjusted taking into account the segments or segment boundaries within the actual audio-video content itself.

In another embodiment the content analyser may be a commercial block detector and the at least one content segmentation marker may be an at least one commercial block segmentation marker. This allows the actual point of resumption of playback of the content to be adjusted to commercial block boundaries rather than the exact point of attention loss.

In another embodiment the playback unit may be arranged to generate an attention loss marker indication, the attention loss marker indication indicating that the at least one point of attention loss has been detected by the attention loss detector and the attention loss marker indication may be made visible to the user. This allows the user to made aware of the fact that a point of attention loss was detected and that the user has the option of resuming playback at such a point. This is a manner of providing useful feedback to the user.

In a further embodiment a device according to the invention may be realized as at least one of the group consisting of a Set-Top-Box device, a digital video recording device, a network-enabled device, a conditional access system, a portable audio player, a portable video player, a mobile phone, a DVD player, a CD player, a hard disk based media player, an Internet radio device, a computer, a television, a public entertainment device and an MP3 player. However, these applications are only exemplary.

In another embodiment of the third aspect of the invention the first device may further comprise a timer unit communicatively coupled to the attention loss storage unit and to the remote device control unit and the at least one attention loss marker stored by the attention loss storage unit may be determined based upon a first current time generated by the timer unit. The remote device control unit may control the second device based upon an elapsed duration between the at least one attention loss marker stored by the attention loss storage unit and a second current time corresponding to reception of the user input. This allows the first device and the second device to be synchronized in time and for the first device to control the second device in an accurate manner.

The data processing required according to the invention can be realized by a computer program, that is to say by software, or by using one or more special electronic optimization circuits, that is to say in hardware, or in hybrid form, that is to say by means of software components and hardware components.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a practical embodiment of the invention.

FIG. 2 illustrates a further embodiment of the invention.

FIG. 3 illustrates an embodiment of the invention making use of a storage unit providing random access.

FIG. 4 illustrates an embodiment suitable for recording live television.

FIG. 5 illustrates an embodiment suitable for detecting commercial blocks.

FIG. 6 illustrates a flowchart for detecting attention loss by a user during playback.

FIG. 7 illustrates a flowchart for resuming playback at a point of attention loss of a user.

FIG. 8a illustrates a flowchart for analysing content.

FIG. 8b illustrates a flowchart for resuming playback taking into account the point of attention loss of a user and segments of content within the content.

FIG. 8c illustrates a flowchart for determining whether a commercial block boundary or the point of attention loss of a user should be stored as the attention loss marker.

FIG. 9 illustrates an embodiment of a system wherein a first device may control a conventional playback device to provide detection of points of attention loss by a user.

FIG. 10 illustrates an embodiment suitable for analysing content during playback without any requirements for pre-processing of the content.

FIG. 11 illustrates a selection of user attention states that may be detected.

The Figures are schematically drawn and not true to scale, and the identical reference numerals in different Figures refer to corresponding elements. It will be clear for those skilled in the art, that alternative but equivalent embodiments of the invention are possible without deviating from the true inventive concept, and that the scope of the invention will be limited by the claims only.

### DETAILED DESCRIPTION OF THE INVENTION

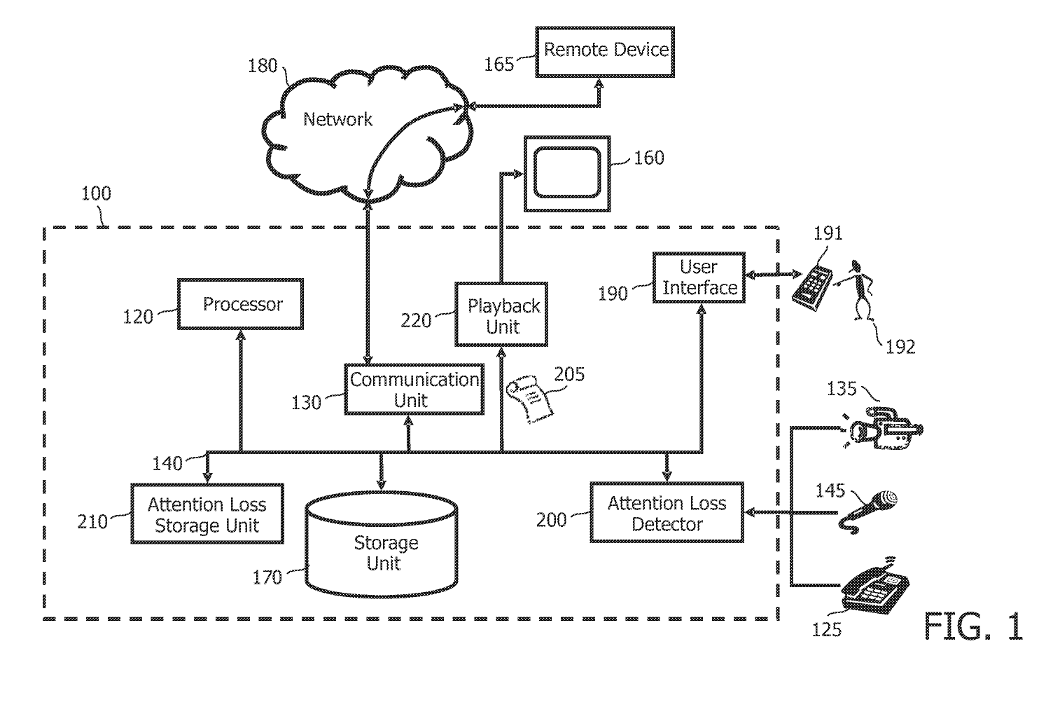

FIG. 1 shows a device 100 according to an embodiment of the invention. The device 100 comprises a storage unit 170, which may be a hard disk drive, a floppy disc drive, a flash memory device, an optical drive or equivalent. The storage unit 170 may be used to store audio-video content 205 that a user 192 would like to preserve or render. The device 100 may, for example, be a hard disk drive/DVD recorder. The device 100 may also comprise a playback unit 220 for decoding the content 205 for display on a display 160. Alternatively, a processor 120 or a codec (not shown) may be used to decode the content 205. Further rendering devices (not shown), such as a speakers, may also be present in the device 100 or externally connected to the device 100. The device 100 may also comprise a communication unit 130, such as an Ethernet interface, in wired or wireless form, a WiFi interface, a Bluetooth interface or a mobile phone network interface. A network interface controller may also be understood as a communication unit 130. The device 100 may then also receive one or more data streams via the communication unit 130 for playing using the playback unit 220 and further display on the display 160 or for storing in the storage unit 170. The communication unit 130 may also be used to transmit data streams to a remote display on a remote device 165 via network 180. The network 180 may be a local network or a worldwide network such as the Internet. The user 192 may interact with the device 100 using a user interface 190. Typically, the user 192 interacts with the user interface 190 using a remote control 191, but other means of interaction are also possible. For example, the user 192 may interact with the device 100 using a touchscreen, a scroll wheel, buttons, a mouse or other pointer device, a keyboard etc.

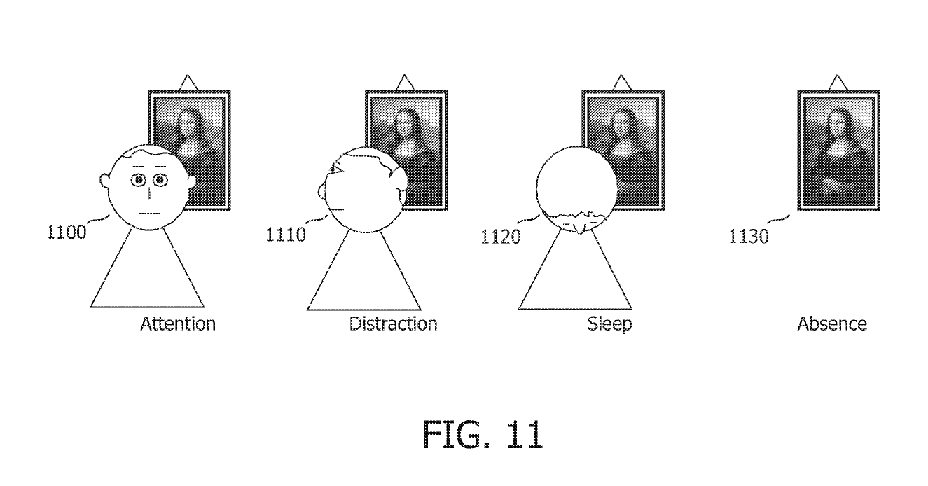

An attention loss detector 200 may be provided to detect instants when the user 192 is distracted from the content 205 being played back and loses attention. The attention loss detector 200 may detect the loss of attention in a variety of ways. For example, when using a camera 135 connected to the attention loss detector 200 face detection and pose estimation may be applied. FIG. 11 illustrates several states or poses that can be identified in order to detect loss of attention. For example, distraction 1110 can be characterized by a change of pose such that the viewer does not face the TV display for a prolonged period of time. This state can be detected with a face detector to localize the faces of the viewers and a pose estimation to detect if any of the faces moves for a long period of time from the frontal state. A sleep state 1120 can also be characterized in the same way, but only if the pose of the viewer changes significantly to a direction other than that of the display. The sleep state 1120 may in some situations occur where the user 192 falls asleep or into a state of drowsiness without his/her pose changing. In that case, the combination of face detection and pose estimation may not suffice to detect that the lost of attention of the user 192. To detect such states, techniques that have been used in the automotive environment to determine the level of a vehicle driver's drowsiness can be used instead. Such techniques are described in U.S. Pat. No. 5,786,765.

The absence state 1130 may be easily detected using face detection. If the face of a viewer is detected before he/she leaves the camera view, absence is determined simply by not being able to detect the face of the viewer for some period of time. Algorithms for face detection and pose estimation are known from the paper “Towards a real-time and distributed system for face detection, pose estimation and face-related features”, Nesvadba et al., Invited Paper, Proc. Int. Con. on Methods and Techniques in Behavioural Research, Wageningen, The Netherlands, 2005. The camera 135 may also be used to focus upon the eyes of the user 192 and detect the direction of gaze or whether the eyes are open or closed.

Of course, there are numerous other methods of detection a loss of attention by the user 192. For example, motion sensors may be used that allow the detection of instants when the user 192 leaves his/her viewing position, a microphone 145 may be employed to detect acoustic signals that may cause distraction. Such acoustic signals may be a door chime or a phone ring tone etc. A telephone 125 or similar communication device may also be directly connected to the attention loss detector 200 to provide a direct signal. Movement of the user 192 may also be detected by tracking his/her movement using an electronic card. For example, as disclosed in US patent application 2004/0104806A1.

An especially useful method of detecting attention loss by the user 192 is by detecting a remote control command from the user 192. Such a remote control command may be transmitted by the remote control 191 and may be a pause command.

An attention loss storage unit 210 may be provided to store points of attention loss detected by the attention loss detector 200. The detection and storing of the points of attention loss may be achieved by the use of a control program running on the processor 120 and making use of a system bus 140. The system bus 140 may interconnect all of the component units comprised within the device 100, allowing the processor 120 to control each component unit. The device 100 may be realized as a Set-Top-Box device, a digital video recording device, a network-enabled device, a conditional access system, a portable audio player, a portable video player, a mobile phone, a DVD player, a CD player, a hard disk based media player, an Internet radio device, a computer, a television, a public entertainment device or an MP3 player. These examples are merely exemplary.

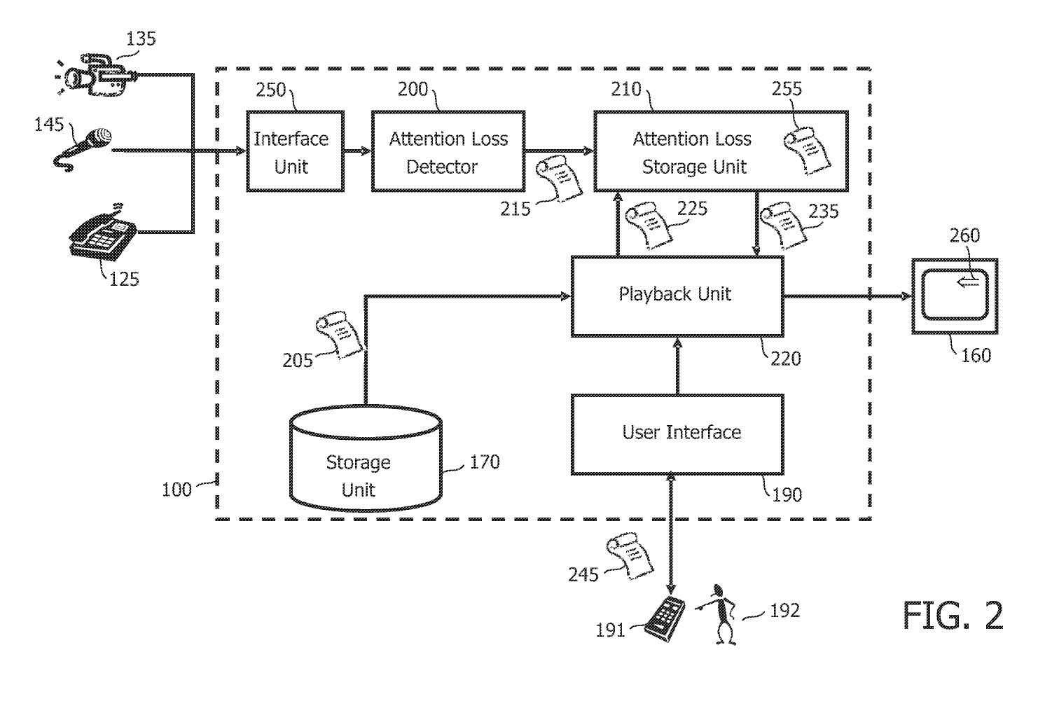

The embodiment of FIG. 2 further elucidates upon the invention. In FIG. 2 the content 205 is retrieved from the storage unit 170 by the playback unit 220 for playback on the display 160. Also in FIG. 2 an interface unit 250 is provided. The interface unit 250 allows many different forms of sensors to be used by the attention loss detector 200 to detect the loss of attention of the user 192. For example, the interface unit 250 may translate a sensor specific value into a reference value or standardised value understood by the attention loss detector 200 of the device 100. The attention loss detector 200 may produce a point of attention loss indication 215 at an instant in time when the user 192 loses attention from the playback of the content 205. The point of attention loss indication 215 may be communicated directly to the attention loss storage unit 210 or via the system bus 140. The attention loss storage unit 210 may generate an attention loss marker 255. Of course, multiple attention loss markers may also be generated and stored in the attention loss storage unit 210 should multiple points of attention loss be detected.

The playback unit 220 may communicate a current playback point 225 to the attention loss storage unit 210 to assist in the generation of the attention loss marker 255. When at least one point of attention loss indication 215 has been detected, or at least one attention loss marker 255 has been generated, the playback unit 220 may in communication with the attention loss storage unit 210 generate an attention loss marker indication 260 for display on the display 160. This indicates to the user 192 that the possibility exists to resume playback from a point in time corresponding to the at least one point of attention loss indication 215 or the at least one attention loss marker 255. The user 192 may then choose to resume playback from a point in time corresponding to the at least one point of attention loss indication 215 by providing user input 245 via the remote control 191 or he/she may ignore the attention loss marker indication 260. Reasons for ignoring the attention loss marker indication 260 could be that the attention loss detector 200 falsely detected the point of attention loss indication 215 or that the user 192 wilfully lost attention due to the content 205 containing a commercial block or other uninteresting segment. Other reasons may also exist for which the user 192 would choose to ignore the attention loss marker indication 260.

Should the user 192 provide the user input 245 to indicate that the user 192 would prefer to resume playback of the content 205 from a point in time corresponding to the point of attention loss 215, the user interface 190 may receive such user input 245. The user interface 190 may then communicate to the playback unit 220 that the point of playback should be changed. The playback unit 220 may then receive a playback pointer 235 from the attention loss storage unit 210. The playback pointer 235 may then be a pointer to a position in the content 205 corresponding to the point of attention loss indication 215. The playback pointer 235 may be a timestamp, or other equivalent indicating a position within the content 205 in time. The playback pointer 235 may also be a file pointer or other equivalent indicating a position in a file representing the content 205. The playback pointer 235 may also be a stream pointer or other equivalent indicating a bit or byte position in a stream representing the content 205. Other examples are also possible. The mere existence of the playback pointer 235 may be used to represent the attention loss marker 255. In such a situation the playback pointer 235 and the attention loss marker 255 may be one and the same. The playback unit 220 makes use of the playback pointer 235 to control the point of playback and sets the playback point to a point corresponding to the playback pointer 235. The user 192 may then view the content 205 on the display 160 from a point in time corresponding to the point of his/her attention loss. Playback may also be resumed a predetermined time before the point corresponding to the playback pointer 235. The predetermined time may be of the order of a few seconds to allow the user 192 to regain context of the content 205. In such a situation the user 192 would first see again a few seconds of the content 205 which were previously displayed on the display 160. In this way the user 192 may regain context and the user 192 may be assured that none of the content 205 has been missed.

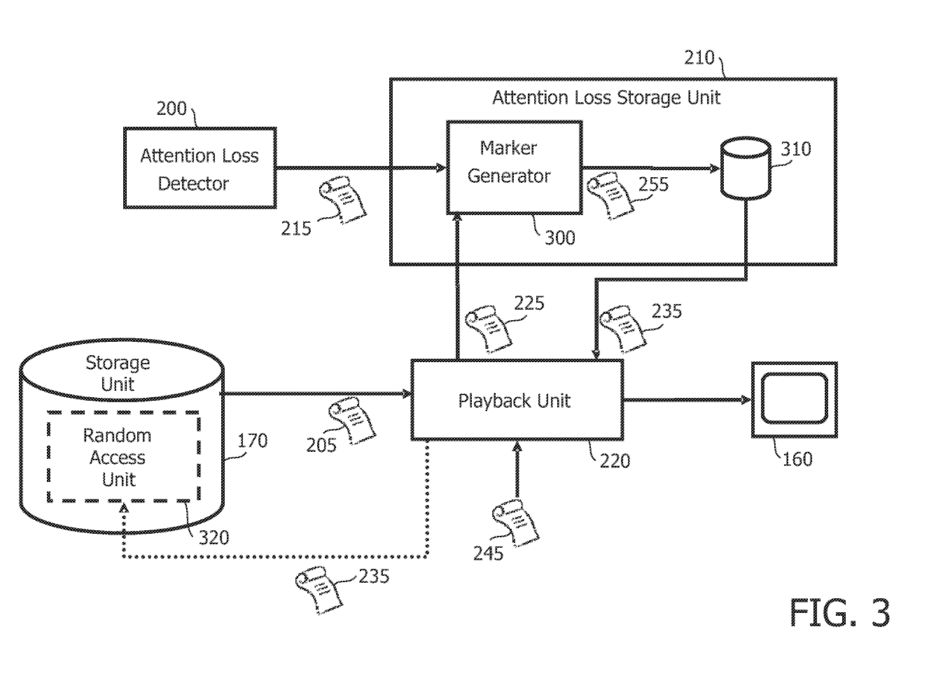

In the embodiment of FIG. 3 the attention loss storage unit 210 is shown as comprising an attention loss marker generator 300. The attention loss marker generator 300 may receive the current playback point 225 from the playback unit 220. This may be provided continuously or upon request of the attention loss storage unit 210. The latter whilst not shown in FIG. 3 is nevertheless possible. The attention loss marker generator 300 may generate the attention loss marker 255 from the current playback point 225 and the point of attention loss indication 215 received from the attention loss detector 200. The attention loss marker 255 may be stored in an attention loss marker database 310. This allows multiple attention loss markers to be stored and retrieved providing the user 192 with more flexibility. The playback pointer 235 may also be stored in the attention loss marker database 310. The relationship between the attention loss marker 255 and the playback pointer 235 has already been described in the text relating to FIG. 2. From this it should be clear that again the attention loss marker 255 and the playback pointer 235 may be one and the same information unit stored in the attention loss marker database 310. Alternatively, the playback pointer 235 may be generated at the time of storing the attention loss marker 255 in the attention loss marker database 310 or at the time of querying the attention loss marker 255 from the attention loss marker database 310. Therefore, the attention loss marker database 310 may be queried by the playback unit 220 to provide the playback pointer 235.

In the embodiment of FIG. 3 the storage unit 170 comprises a random access unit 320. The random access unit 320 permits the storage unit 170 to access the content 205 in a randomly addressable manner. This may be achieved in a variety of ways depending upon the exact form taken by the storage unit 170. For example, if the storage unit 170 is a hard disk drive or a flash memory device the random access unit 320 may make use of addressable sectors. The addressable sectors may further represent logical or physical sectors in the hard disk drive. Such logical sectors have addresses that are commonly referred to as Logical Block Addresses, or LBA's. When the storage unit 170 takes the form of an optical disk drive the addressable sectors may also represent logical or physical sectors in the accompanying optical medium. Whatever form taken by the storage unit 170, the random access unit 320 may accept an address, such as the playback pointer 235 or an address corresponding to the playback pointer 235, and move a read/write head within the storage unit 170 to a location indicated by the playback pointer 235 or the address corresponding to the playback pointer 235.

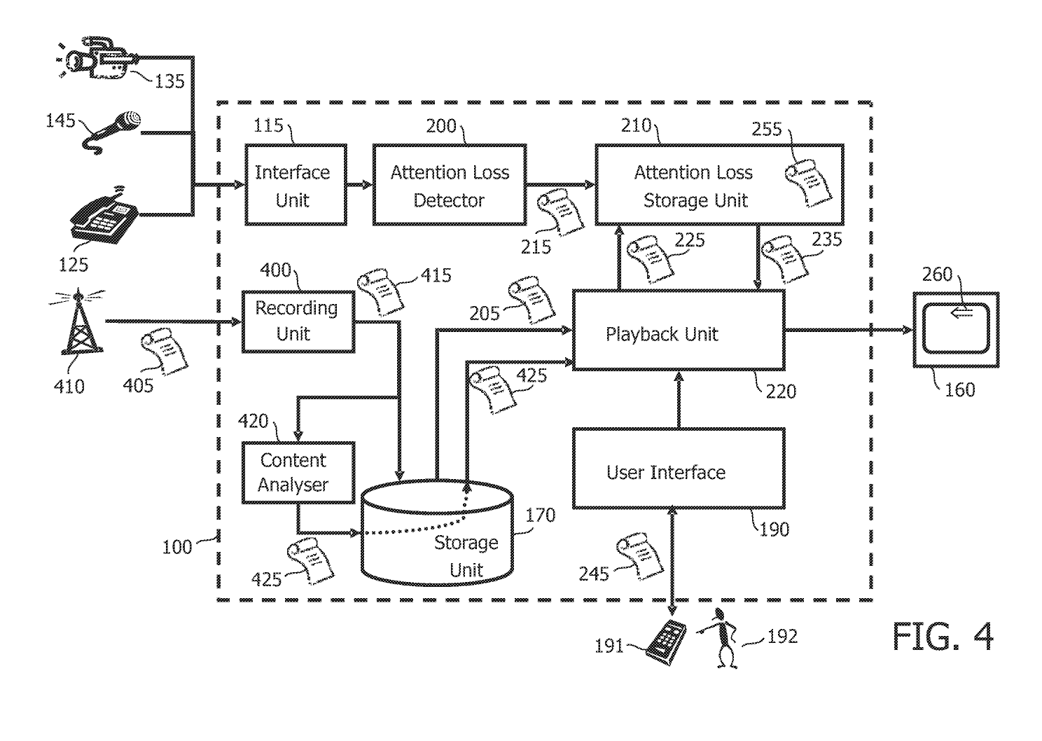

In the embodiment of FIG. 4 a recording unit 400 may be used to record a broadcast signal 405. The broadcast signal 405 may be television signal received via a broadcast receiver 410. The broadcast receiver 410 may be an antenna, a cable receiver, a satellite receiver, an Internet Protocol television (IPTV) receiver or the like. The broadcast signal 405 may also be a radio signal. The broadcast signal may, in fact, be any form of audio-visual signal. The recording unit 400 may demodulate or demultiplex content to be recorded 415. The content to be recorded 415 may then be directly stored on the storage unit 170 or may also be analysed by a content analyser 420. The content analyser 420 may analyse the content to be recorded 405 in real-time during recording or it may analyse the content to be recorded 405 offline at a time later than the actual recording time. The task of the content analyser 420 is to segment the content to be recorded 415 into various segments. Content segmentation markers 425, which may be stored in the storage unit 170 or elsewhere, may identify the various segments. The content segmentation markers 425 may alternatively be embedded within the content to be recorded 415 as an auxiliary stream of information. The segments may be portions of the content 205 that may possess a semantic relationship to each other for the user 192. For example, the segments may be a number of scenes all shot in the same location, or they may be a number of scenes comprising of alternating faces of characters in a film having a conversation. The exact semantic relationship is not important for the invention.

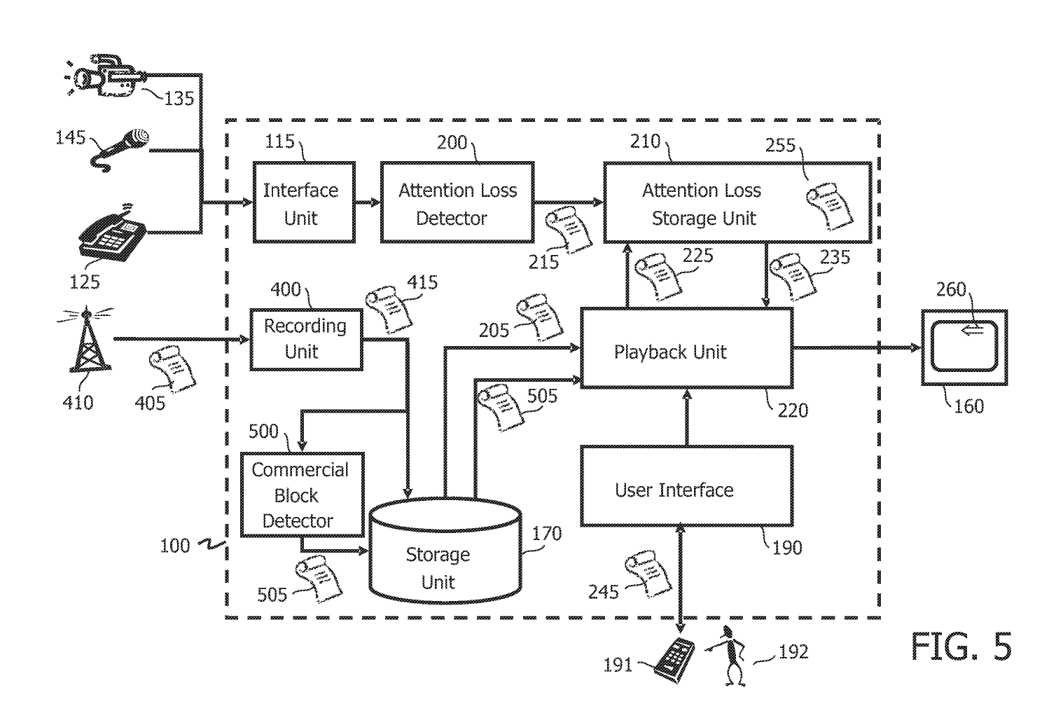

The content analyser 420 may use any known algorithm to identify the various segments within the content. For example, the content analyser 420 may analyse the compressed or decompressed pixel values to determine scene or shot changes. The content analyser 420 may also analyse the compressed or decompressed audio signal to determine explicit events or regions of high volume indicating exciting portions of the content to be recorded 415. Content analysis algorithms are known which may detect sky, grass, faces, explosions etc. The exact algorithm used to analyse the content to be recorded 415 is not important. The content segmentation markers 425 may be communicated to the playback unit 220 such that the playback unit 220 may adjust the playback pointer 235 received from the attention loss storage unit 210 to coincide with one of the content segmentation markers 425. This permits the resumption of playback to become context aware. For example, playback may be resumed from the start of a scene or shot rather than at an arbitrary point in time located within the content 205 where the user 192 lost attention. Playback may also be resumed a predetermined time before the point in time where the user 192 lost attention or a predetermined time before one of the content segmentation markers 425. The predetermined time may be of the order of a few seconds to allow the user 192 to regain a context of the content 205. The possibilities may be explained more thoroughly by referring to the embodiment of FIG. 5 in which commercial blocks are detected.

The embodiment of FIG. 5 shows a device 100 capable of analysing the content to be recorded 415 for commercial blocks, i.e. advertisements. In FIG. 5 the content analyser 420 may be a commercial block detector 500 and the content segmentation markers 425 may be commercial block segmentation markers 505. As is known the commercial block detector 500 may use a variety of low level features of the content to be recorded 415 to determine commercial blocks. For example, the appearance and disappearance of channel logo's may be detected. Shot cuts, cross fades or black frames may be detected. Changes in the audio level may be detected. Again any suitable commercial block detection algorithm may be used. The commercial block segmentation markers 505 may be used, by the playback unit 220, to determine from which point the content 205 should be played. For example, if the playback unit 220 determines that the playback pointer 235 received from the attention loss storage unit 210 corresponds to a point in time during a commercial block then the playback unit 220 may decide to play the content 205 from the end of the commercial block, rather than the playback pointer 235. In other words the playback pointer 235 may be modified by taking into account the commercial block segmentation markers 505. This modified playback pointer may then be used to address the content 205 on the storage unit 170. In such a situation the user 192 would view the content 205, after supplying the user input 245, from the end of the commercial block rather than from the exact point in time when the user 192 lost attention. This would, in most cases, be a far more preferable mode of operation for the user 192.

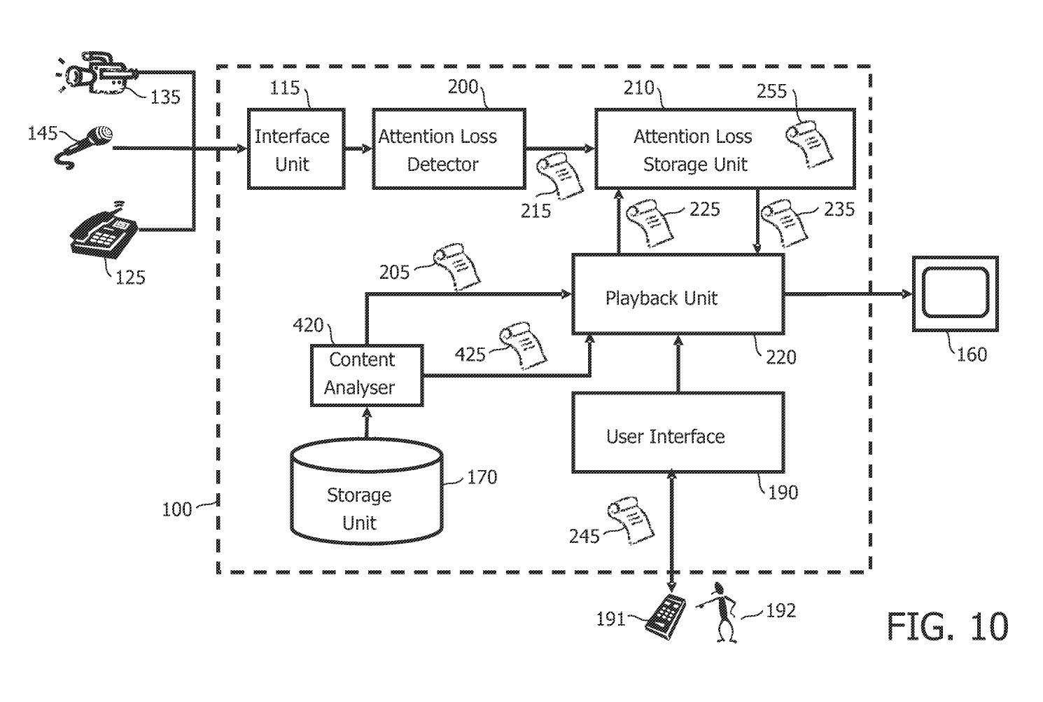

In the embodiment of FIG. 10 the content analyser 420 is positioned to analyse the content 205 during playback. The content analyser 420 would preferably run at real-time or even faster than real-time in such an embodiment. This embodiment would be useful when the content 205 arrives from a source that is not capable of providing the content segmentation markers 425. The arrival may be from a network connection via the communication unit 130 or via a removable storage medium in cooperation with the storage unit 170. The content analyser 420 may operate in a manner equivalent to that as described in the text relating to FIG. 4. The content analyser 420 of FIG. 10 may also be a commercial block detector 500 and may operate as described in the text relating to FIG. 5.

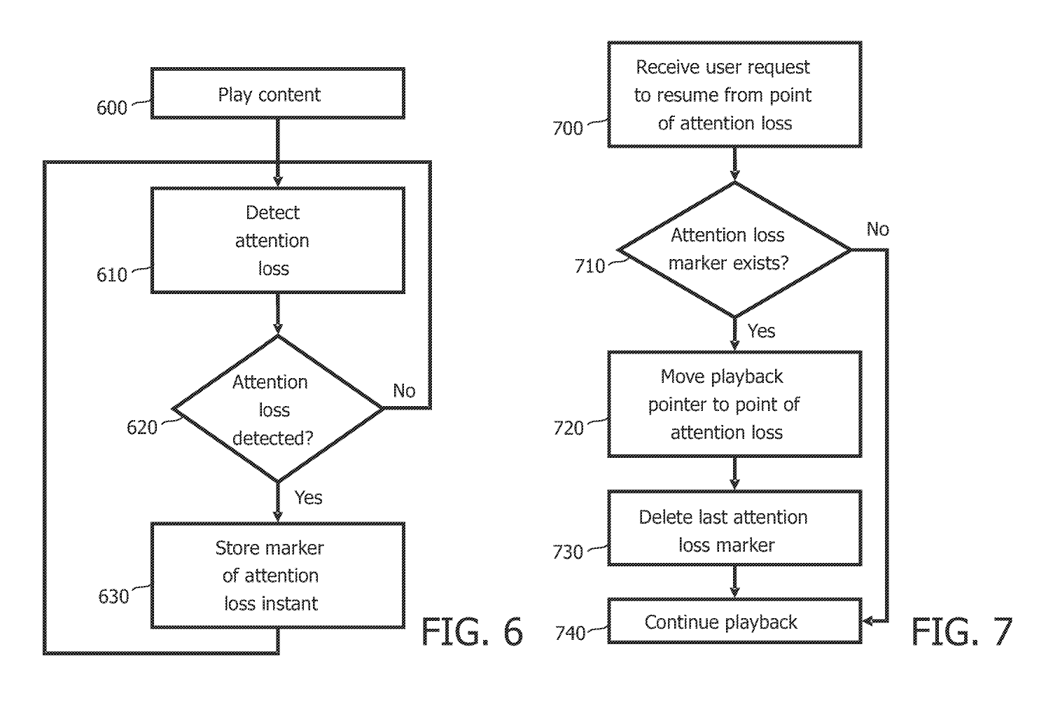

In FIG. 6 a flowchart is shown that illustrates a method for detecting attention loss by the user 192 during playback of the content 205. The method of FIG. 6 may be implemented in a control program running on the processor 120 of the device 100. Initially at step 600, the content 205 may be played. The content 205 may be played on the display 160 or rendered on a display on, or connected to, the remote device 165. At step 610 the attention of the user 192 may be detected and as such attention loss may be detected at decision point step 620. Steps 610 and 620 may be combined into a single step of detecting user attention loss. Step 620 may generate the point of attention loss indication 215. The point of attention loss indication 215 may be used in step 630 to store a marker, such as the attention loss marker 255. At this point the process of detecting and storing any points of attention loss by the user 192 is complete.

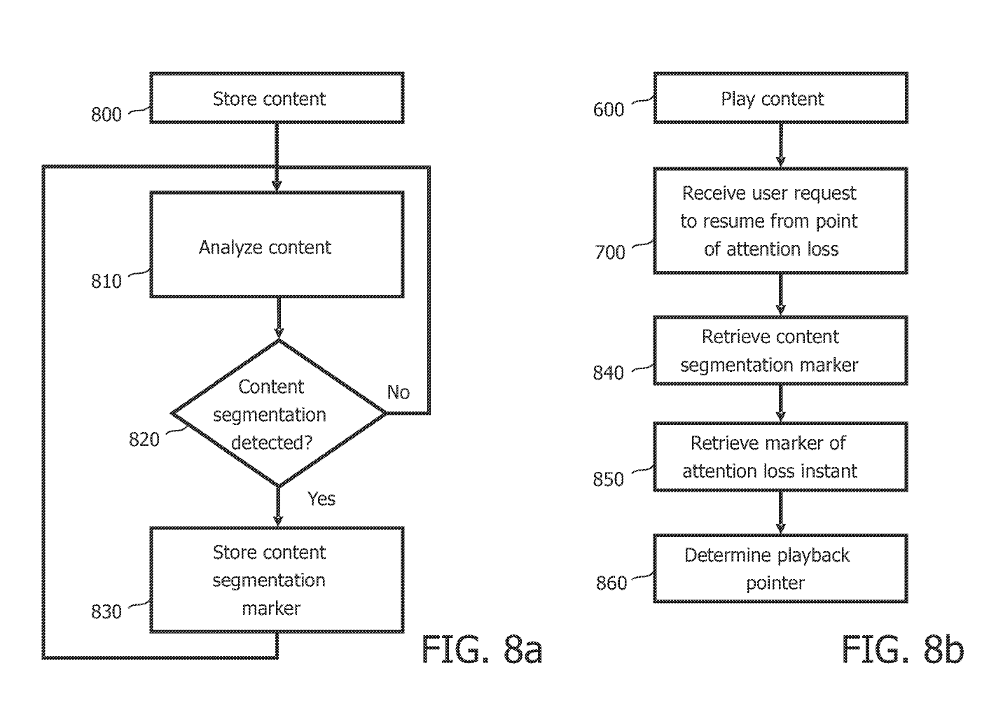

FIG. 7 illustrates a flowchart for resuming playback at a point of attention loss of the user 192. The process of FIG. 7 may also be implemented in a control program running on the processor 120 of the device 100. The process of FIG. 7 begins at step 700 by receiving a user request to resume playback of the content 205 from a point in time corresponding to a point of attention loss by the user 192. Such a user request may be the user input 245. At step 710 a check is performed upon whether or not the attention loss marker 255 exists. If not, playback is continued at step 740 without any modification of the point of playback. If the attention loss marker 255 does exist the playback pointer 235 is retrieved from the attention loss storage unit 210 or determined by the playback unit 220. The playback unit 220 and the storage unit 170 cooperate such that the content 205 is played from a point in time corresponding to the loss of attention by the user 192. The attention loss marker 255 may then be deleted in step 730, before playback is resumed in step 740. However, playback now proceeds from the modified point of playback, i.e. the point in time corresponding to the loss of attention by the user 192.

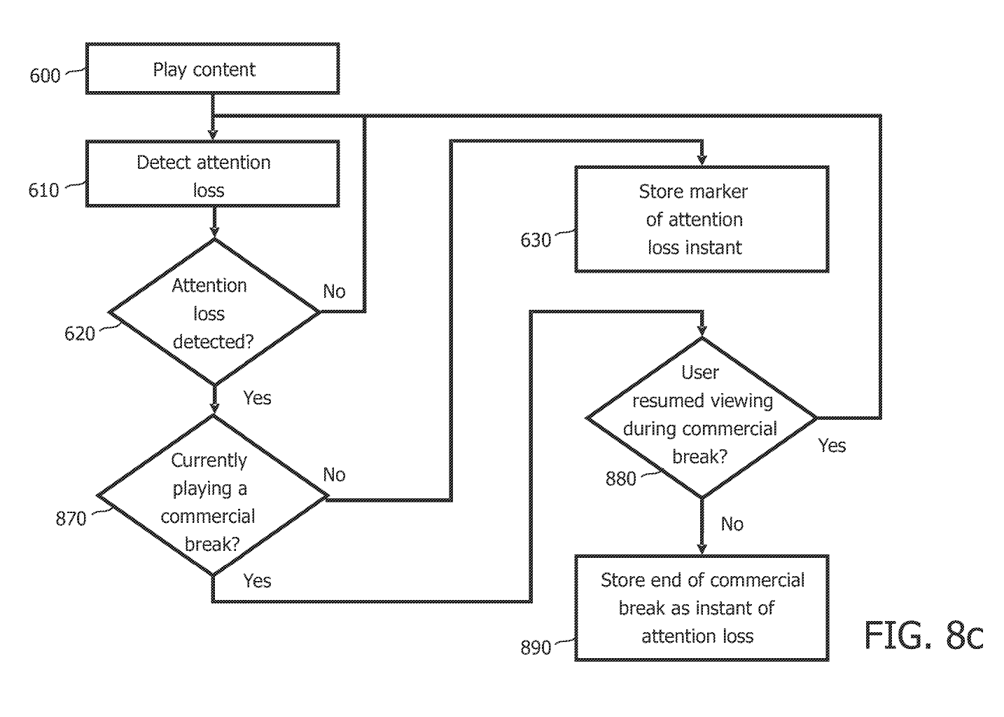

FIG. 8a illustrates a flowchart for analysing content that may also be implemented in a control program running on the processor 120. In step 800 the content 205 is stored. This may optionally be performed outside of the device 100, in which case step 800 merely comprises a step of accessing the content 205. This would be the case when the content 205 originates from another source. For example, when the content 205 is transferred using an optical disc medium. In step 810 the content 205 is analysed. The various methods of analysing the content 205 have been described in the text relating to the embodiments of FIG. 4, FIG. 5 and FIG. 10. In step 820 a decision point is reached wherein it is decided whether any segments have been detected within the content 205. If not, then the remaining portions of the content 205 may be analysed. If segments are detected within the content 205 then one or more of the content segmentation markers 425 may be generated and stored in step 830, before the remaining portions of the content 205 may be analysed.

FIG. 8b illustrates a process for resuming playback taking into account the point of attention loss of the user 192 and segments of content within the content 205. Again the process of FIG. 8b may be implemented in a control program running on the processor 120. In FIG. 8b the process begins at step 600 where the content 205 is being played or playing is initiated. At step 700 a user request is received. The user request indicates that the user 192 would wish to resume playback of the content 205 from a point in time corresponding to a point of attention loss by the user 192. Such a user request may be the user input 245. In step 840 the content segmentation markers 425 generated during analysis of the content 205 may be retrieved. In step 850 the attention loss marker 255 or the playback pointer 235 may be retrieved. In step 860 a modified playback pointer may be determined taking into account the content segmentation markers 425 and the playback pointer 235 or the attention loss marker 255. This has been described in detail in the text describing the embodiments of FIG. 4, FIG. 5 and FIG. 10. The playback unit 220 may use the modified playback pointer to resume playback of the content 205 from a point in time more preferable to the user 192 than the actual point in time where attention of the user 192 was lost.

In FIG. 8c a flowchart is shown that illustrates a method for determining whether a commercial block boundary or a point of attention loss of the user 192 should be stored as the attention loss marker 255. The process of FIG. 8c may also be implemented in a control program running on the processor 120. The process of FIG. 8c may be used when recording in real-time or when playing back content from a source that does not provide any information about commercial block boundaries. This is not however a limitation of the process of FIG. 8c and information about commercial block boundaries may equally well be provided and used by the process of FIG. 8c. The process of FIG. 8c begins at step 600 where the content 205 is played. At step 610 any points where the user 192 loses attention are detected. An especially useful method of detecting attention loss by the user 192 is by detecting a remote control command from the user 192. Such a remote control command may be transmitted by the remote control 191 and may be a pause command. In this example, the content 205 may still be played, i.e. the pause command may not be honoured, but the point of attention loss indication 215 will be generated. In step 620 the process may diverge based upon whether the user 192 has lost attention or not. If not, the attention loss detection process of step 610 is repeated. If a point of attention loss is detected then at step 870 it is decided whether or not the content 205 currently being played is a commercial block or not. The step 870 may comprise the process of analysis of the content 205 or may comprise merely of the process of retrieving any previously stored commercial block segmentation markers 505. If the point of attention loss is not within a commercial block then the process proceeds to step 630 where the point of attention loss indication 215 may be used to store a marker, such as the attention loss marker 255. At this point the process of detecting and storing any points of attention loss by the user 192 is complete. The process may then be restarted.

If the point of attention loss is within a commercial block then the process proceeds to step 880 where a check is performed as to whether the user 192 is to resume viewing of the content 205 within the commercial block. If this is so then the process proceeds further by progressing to step 610 wherein any new points of attention loss by the user 192 may be detected. If the user 192 has not resumed viewing of the content 205 by the time of the end of the commercial block then in step 890 the end of the commercial block may be stored as the instant of attention loss rather than the actual point of attention loss by the user 192. In other words, the attention loss marker 255 may be modified from referring to the point of attention loss indication 215 to refer to the end of the commercial block instead. This is a preferable point in time to resume viewing for the user 192 than actual point of attention loss. The playback pointer 235 may also be modified to refer to the end of the commercial block depending upon the exact implementation. Modification of the attention loss marker 255 and/or the playback pointer 235 may therefore be performed during the storing of the content 205, i.e. when attention loss and commercial blocks have actually been detected, or during the resumption of the playback of the content subsequent to the reception of the user input 245, i.e. after a request by the user 192 to resume playback from a point in time corresponding to the loss of attention by the user 192.

There are many methods of operation possible. For example, when the attention loss is indicated by a pause command received from the user 192 and within a commercial block, the content 205 may actually be paused but the device 100 may continuously search for the end of the commercial block and automatically move the paused location to coincide with the end of a commercial block when detected. Another possibility is that the content is not paused, but the attention loss marker 255 is generated and stored and the attention loss marker indication 260 is generated to acknowledge to the user 192 that a resume point has been preserved. This resume point may again be modified when the point of attention loss coincides with a commercial block and the resume point may be moved to coincide with the end of the commercial block.

Since the attention loss marker 255 and/or the playback pointer 235 may have been modified to refer to the end of the commercial block the process of FIG. 7 may be used unmodified to resume playback from a suitable point.

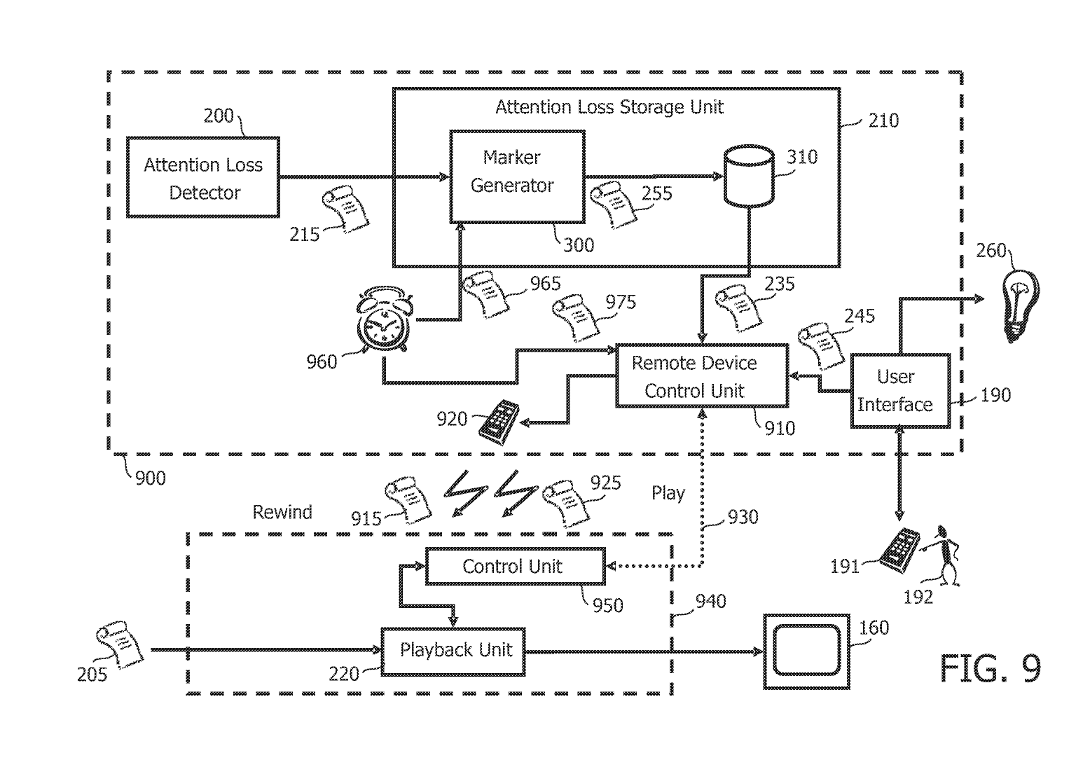

FIG. 9 shows a system comprising a first device 900 and a second device 940. The second device 940 may be a traditional device for playing back the content 205. The second device 940 may be a VHS tape player/recorder, a personal video recorder (PVR) such as a hard disk drive recorder, a DVD/optical disc recorder, etc. The second device 940 may comprise the playback unit 220 to play back the content 205 and a control unit 950 capable of receiving external commands for controlling the playback of the content 205. The external commands may be normal remote control commands, such as a play command 925, a pause command, a rewind command 915, a forward command etc. and may be received from a remote control or another equivalent control. The external commands may also be received via a digital control interface 930, such as an IEEE1394 interface, a SCART interface, etc. The remote control commands should, in this embodiment, at least be able to control the playback of the content 205 using the playback unit 220. The second device 940 may present the content 205 on the display 160.

The first device 900 may comprise the attention loss detector 200 and as described earlier may generate the point of attention loss indication 215. The point of attention loss indication 215 may be communicated to the attention loss storage unit 210 of the first device 900. The attention loss storage unit 210 may generate the attention loss marker 255 based upon the point of attention loss indication 215 and a first current time 965. The first current time 965 may be the current time as generated by a timer unit 960 at the instant that the point of attention loss indication 215 is detected. The timer unit 960 may be a real time clock, a crystal time base or the like. The attention loss marker 255 may be generated by the attention loss marker generator 300 and stored in the attention loss marker database 310. The first device 900 may further comprise a remote device control unit 910. The remote device control unit 910 may receive the user input 245 via the user interface 190 and control the second device 940 such that the second device 940 plays and/or resumes playback of the content 205 from a point in time corresponding to the point of attention loss of the user 192. The remote device control unit 910 may, upon receiving the user input 245, acquire a second current time 975 from the timer unit 960. The second current time 975 may be the current time as generated by the timer unit 960 at the instant that the user input 245 is received. This allows the duration to be determined between the first current time 965 and the second current time 975.

Based upon this duration the remote device control unit 910 may control the second device 940 using predetermined knowledge of remote control commands, second device reaction times etc. The remote control commands, such as the rewind command 915 and the play command 925, may be communicated from the first device 900 to the second device 940 via a remote control transmitter 920 of the first device 900 or via the digital control interface 930, or via another suitable manner. The attention loss marker indication 260 may be produced in the first device 900 in response to the detection of at least one point of attention loss of the user 192. The attention loss marker indication 260 may be as simple as a visual indication visible to the user 192, such as a light emitting diode, LED, or may be as complicated as a video overlay mixed over the content 205. In the latter case the content 205 may be diverted from the second device 940 through the first device 900 and then displayed upon the display 160.

In summary the invention discloses methods and devices for playing audio-video content 205 during which loss of attention of the user 192 is detected. Any loss of attention of the user 192 generates the at least one attention loss marker 255, or bookmark, that is stored in an attention loss storage unit 210. The user 192 may revert playback to a point in time corresponding to the attention loss marker using the user interface unit 190. By storing markers corresponding to points of attention loss by the user 192 and requiring explicit user input 245, the attention loss detector may detect attention loss with an accuracy lower than would otherwise be the case. Optionally, storing of the attention loss markers may be made conditional upon a content analysis unit 420, such as a commercial block detector 500. An attention loss marker indication 260 may be made visible to the user to indicate that at least one attention loss marker has been detected.

It should be noted that the above-mentioned embodiments illustrate rather than limit the invention, and that those skilled in the art will be capable of designing many alternative embodiments without departing from the scope of the invention as defined by the appended claims. Furthermore, any of the embodiments described comprise implicit features, such as, an internal current supply, for example, a battery or an accumulator. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A device (100) for playing audio-video content (205), the device comprising:
a storage unit (170) for supplying the content to be played;
a playback unit (220) for playing the content from the storage unit;
an attention loss detector (200) for detecting at least one point of attention loss by a user (192) during playing of the content by the playback unit;
an attention loss storage unit (210) for storing at least one attention loss marker (255) corresponding to the at least one point of attention loss detected by the attention loss detector; and
a user interface unit (190) for receiving user input (245) from the user indicating that the playback unit should play the content from a point in time corresponding to the at least one attention loss marker.

2. The device of claim 1 wherein the attention loss storage unit comprises:
an attention loss marker generator (300) communicatively coupled to the attention loss detector and the playback unit, for generating the at least one attention loss marker (255) based upon a current playback point (225) received from the playback unit and a point of attention loss indication (215) received from the attention loss detector; and
an attention loss marker database (310) communicatively coupled to the attention loss marker generator and the playback unit, for storing and retrieving the at least one attention loss marker generated by the attention loss marker generator.

3. The device of claim 1 wherein
the storage unit (170) comprises a random access unit (320) for playing the content in an randomly addressable manner;
the playback unit is communicatively coupled to the storage unit to provide a playback pointer (235) to address the content from the storage unit in the randomly addressable manner; and wherein
the user interface unit (190) is communicatively coupled to the playback unit to indicate that the playback unit should communicate the playback pointer to the storage unit to play the content from a point in time corresponding to the at least one attention loss marker.

4. The device of claim 1 further comprising a recording unit (400) for recording a broadcast signal (405), the recording unit being communicatively coupled to the storage unit to record the broadcast signal.

5. The device of claim 4 further comprising
a content analyser (420) communicatively coupled to the recording unit (400) for analysing the content and generating at least one content segmentation marker (425) indicating at least one segment within the content,
the content analyser (420) being further communicatively coupled to the storage unit (170) for storing the at least one content segmentation marker, and wherein
the playback unit is communicatively coupled to the storage unit to determine a playback pointer (235) based upon the point in time corresponding to the at least one attention loss marker and the at least one content segmentation marker, the playback unit further being adapted to play the content from a point in time corresponding to the playback pointer.

6. The device of claim 1 further comprising
a content analyser (420) communicatively coupled to the storage unit (170) for analysing the content and generating at least one content segmentation marker (425) indicating at least one segment within the content, and wherein
the playback unit is communicatively coupled to the content analyser to determine a playback pointer (235) based upon the point in time corresponding to the at least one attention loss marker and the at least one content segmentation marker, the playback unit further being adapted to play the content from a point in time corresponding to the playback pointer.

7. The device of claim 5 wherein the content analyser is a commercial block detector (500) and the at least one content segmentation marker is an at least one commercial block segmentation marker (505).

8. The device of claim 1 wherein the playback unit is arranged to generate an attention loss marker indication (260), the attention loss marker indication indicating that the at least one point of attention loss has been detected by the attention loss detector and wherein the attention loss marker indication is made visible to the user.

9. The device of claim 1 realized as at least one of the group consisting of:
a Set-Top-Box device;
a digital video recording device;
a network-enabled device;
a conditional access system;
a portable audio player;
a portable video player;
a mobile phone;
a DVD player;
a CD player;
a hard disk based media player;
an Internet radio device;
a computer;
a television;
a public entertainment device; and
an MP3 player.

10. A method for playing audio-video content (205), the method comprising:
playing (600) the content to a user (192);
detecting (610) at least one point of attention loss by the user during the playing of the content;
storing (630) at least one attention loss marker (255) corresponding to the at least one point of attention loss detected;
receiving (700) user input (245) from the user indicating that the user desires to play the content from a point in time corresponding to the at least one attention loss marker; and
playing (720) the content from a point in time corresponding to the at least one attention loss marker in response to the user input.

11. The method of claim 10 further comprising:
analysing (810) the content;
generating (830) at least one content segmentation marker (425) indicating at least one segment within the content detected in the step of analysing; and
determining (860) a playback pointer (235) based upon the point in time corresponding to the at least one attention loss marker and the at least one content segmentation marker.

12. The method of claim 11 wherein the method step of analysing (810) further comprises detecting commercial blocks within the content, and wherein the playback pointer is determined (890) further based upon the commercial blocks detected within the content.

13. A system for playing audio-video content (205), comprising:
a first device (900), for detecting attention loss; and
a second device (940), the second device comprising a playback unit (220) for playing the content; wherein
the first device comprises:
an attention loss detector (200) for detecting at least one point of attention loss by a user (192) during playing of the content by the second device;
an attention loss storage unit (210) for storing at least one attention loss marker (255) corresponding to the at least one point of attention loss detected by the attention loss detector;
a user interface unit (190) for receiving user input (245) from the user indicating that the content should be played from a point in time corresponding to the at least one attention loss marker; and
a remote device control unit, for controlling the playback unit of the second device in response to the user input to play the content from the point in time corresponding to the at least one attention loss marker.

14. The system of claim 13, wherein the first device further comprises:
a timer unit (960) communicatively coupled to the attention loss storage unit and to the remote device control unit; and wherein
the at least one attention loss marker stored by the attention loss storage unit is determined based upon a first current time (965) generated by the timer unit; and
the remote device control unit controls the second device based upon an elapsed duration between the at least one attention loss marker stored by the attention loss storage unit and a second current time (975) corresponding to reception of the user input.

15. A program element directly loadable into a memory of a programmable device, comprising software code portions for performing, when said program element is run on the device, the method steps of:
playing (600) audio-video content to a user (192);
detecting (610) at least one point of attention loss by the user during the playing of the content;
storing (630) at least one attention loss marker (255) corresponding to the at least one point of attention loss detected;
receiving (700) user input (245) from the user indicating that the user desires to play the content from a point in time corresponding to the at least one attention loss marker; and
playing (720) the content from a point in time corresponding to the at least one attention loss marker in response to the user input.

16. A computer-readable medium directly loadable into a memory of a programmable device, comprising software code portions for performing, when said code portions are run on the device, the method steps of:
playing (600) audio-video content to a user (192);
detecting (610) at least one point of attention loss by the user during the playing of the content;
storing (630) at least one attention loss marker (255) corresponding to the at least one point of attention loss detected;
receiving (700) user input (245) from the user indicating that the user desires to play the content from a point in time corresponding to the at least one attention loss marker; and
playing (720) the content from a point in time corresponding to the at least one attention loss marker in response to the user input.
